(19) United States
(12) Patent Application Publication
(10) Pub. No.: US 2023/0092152 A1
(43) Pub. Date: Mar. 23, 2023

(54) CONTROLLED EXPOSURE OF STATISTICAL INFORMATION

(71) Applicant: Intel Corporation, Santa Clara, CA (US)

(72) Inventors: Ofir Shwartz, Haifa (IL); David Deitcher, Jerusalem (IL)

(73) Assignee: Intel Corporation, Santa Clara, CA (US)

(21) Appl. No.: 17/482,965

(22) Filed: Sep. 23, 2021

(51) Int. Cl. G06F 21/62; G06F 21/44; G06F 21/60; G06F 12/14

(52) U.S. Cl. CPC G06F 21/6227; G06F 21/44; G06F 21/602; G06F 12/1458; G06F 12/1441; G06F 2221/2141

(57) ABSTRACT

An embodiment of an integrated circuit may comprise a management controller and circuitry communicatively coupled to the management controller, the circuitry to apply two or more respective controls to statistical data from two or more respective data sources in accordance with respective configuration information for each data source, and store the statistical data in a memory in accordance with the applied two or more controls. Other embodiments are disclosed and claimed.

### BACKGROUND

### 1. Technical Field

This disclosure generally relates to controller technology, and telemetry technology.

### 2. Background Art

Telemetry generally refers to remote measurement. In the electronics field, telemetry may refer to local collection of measurements or other data at remote points and the transmission of the same to monitoring equipment. Telemetry data may be collected from multiple data sources and may be transmitted by wireless or wired communication processes for monitoring or analysis.

In the computer field, diagnostic and/or performance data may be considered a form of telemetry. Such data may be monitored or collected and analyzed to tune the performance of a computer system. A central processor unit (CPU) may include CPU counters that store the count of various hardware-related events. The CPU counter information may be collected and analyzed to tune the performance of the CPU.

### BRIEF DESCRIPTION OF THE DRAWINGS

The various embodiments of the present invention are illustrated by way of example, and not by way of limitation, in the figures of the accompanying drawings and in which:

FIG. 1 is a block diagram of an example of an integrated circuit according to an embodiment;

FIGS. 2A to 2B are flow diagrams of an example of a method according to an embodiment;

FIG. 3 is a block diagram of an example of an apparatus according to an embodiment;

FIG. 4 is a block diagram of an example of a system according to an embodiment;

FIG. 5 is an illustrative diagram of an example of a process flow according to an embodiment;

FIG. 6 is a block diagram of an example of a system-on-a-chip (SoC) according to an embodiment;

FIG. 7 is a block diagram of an example of computing device according to an embodiment;

FIG. 8A is a block diagram illustrating both an exemplary in-order pipeline and an exemplary register renaming, out-of-order issue/execution pipeline according to embodiments of the invention;

FIG. 8B is a block diagram illustrating both an exemplary embodiment of an in-order architecture core and an exemplary register renaming, out-of-order issue/execution architecture core to be included in a processor according to embodiments of the invention;

FIGS. 9A-B illustrate a block diagram of a more specific exemplary in-order core architecture, which core would be one of several logic blocks (including other cores of the same type and/or different types) in a chip;

FIG. 10 is a block diagram of a processor that may have more than one core, may have an integrated memory controller, and may have integrated graphics according to embodiments of the invention;

FIGS. 11-14 are block diagrams of exemplary computer architectures; and

FIG. 15 is a block diagram contrasting the use of a software instruction converter to convert binary instructions in a source instruction set to binary instructions in a target instruction set according to embodiments of the invention.

### DETAILED DESCRIPTION

Embodiments discussed herein variously provide techniques and mechanisms for controlled exposure of statistical information. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to control exposure of statistical information.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some embodiments provide technology for controlled exposure of statistical information. To meet ever increasing performance demands, chip and system manufacturers develop advanced techniques to enhance performance of their devices. Some examples are out of order execution, parallelism, etc. Runtime statistical information may be utilized to improve or optimize a device or system.

Optimizations based on runtime statistical information may be beneficial because the system may be tuned to the actual needs of the workload. Information such as performance counters and telemetry spread around the device may be monitored and provided to various agents to make decisions accordingly. Non-limiting examples of such agents include firmware components (e.g. to tune power budgets) and runtime software (e.g., to tune application scheduling).

However, the use of such statistical information involves a significant risk of exposing security sensitive information to unauthorized entities. For example, the statistical information flow may be more susceptible to various side-channel attacks. For example, telemetry information may be used by an attacker to steal secret keys of an application running within a trusted execution environment (TEE), and performance counters may expose information between neighboring mutually untrusted virtual machines (VMs).

Chip and system manufacturers attempt to reduce the risk by performing security reviews of the statistical information exposed. However, malevolent actors are also working to improve their ability to expose vulnerabilities using statistical information. A product or device that is proven safe at manufacturing cannot assumed to stay safe throughout its lifetime. In some cases, the statistical information collected may have little or no controls. Where the collection of the statistical information can be disabled, a conventional approach to a later discovered vulnerability with the collection of such statistical information may involve completely disabling the data collection/optimization features, resulting in dropping features and/or harming performance of products in the field. A problem is that conventional collection of statistical information lacks fine granularity control to defeat attacks.

Advantageously, some embodiments may overcome one or more of the foregoing problems. Some embodiments may provide technology to control exposure of statistical information for devices or products that are in the field. In some embodiments, a set of controls may be implemented to limit the usability and exposure of the statistical information. Embodiments of the implemented controls may, for example, limit the accuracy of the statistical information, the context covered by the statistical information, and/or the access control to the statistical information. Suitable logic and/or circuitry to implement the telemetry control technology described herein may be incorporated at any suitable location in a computer system between one or more sources of telemetry data (e.g., diagnostic data, performance data, etc.) and the storage of the telemetry data. In some embodiments, the telemetry control technology is incorporated in another controller in the system that is suitably located in the data path.

Different electronic systems or platforms may include a variety of controllers including, for example, a memory controller (MC), a system management controller (SMC), a power management unit (PMU or P-Unit), a power control unit (PCU), a system management unit (SMU), a power management integrated circuit (PMIC), a baseboard management controller (BMC), etc. A PCU, P-Unit, or PMIC may be implemented as a microcontroller that governs power and other functions of a system/platform. The P-unit/PMIC may include its own dedicated firmware/software, memory, a central processor unit (CPU), input/output (TO) functions, timers, analog-to-digital (A/D) converters, etc. In some systems, the PCU/P-Unit/PMIC may remain active even when the system is otherwise shut down. Although nominally referred to for its power management capabilities, the PCU/P-Unit/PMIC may also manage other functions such as IO, interfacing with built in keypads/touchpads, clock regulation, etc. Likewise, other management controllers that do not nominally refer to power management (e.g., a SMU, a SMC, a BMC), may also manage power or power-related functions. A BMC may also be implemented as a microcontroller, generally located on a motherboard of a system/platform (e.g., a server). The BMC may include its own firmware/memory/etc. and manages an interface between system-management software and platform hardware. In accordance with some embodiments, one or more of the foregoing example controllers may be further configured with the telemetry control technology described herein to control exposure of statistical information.

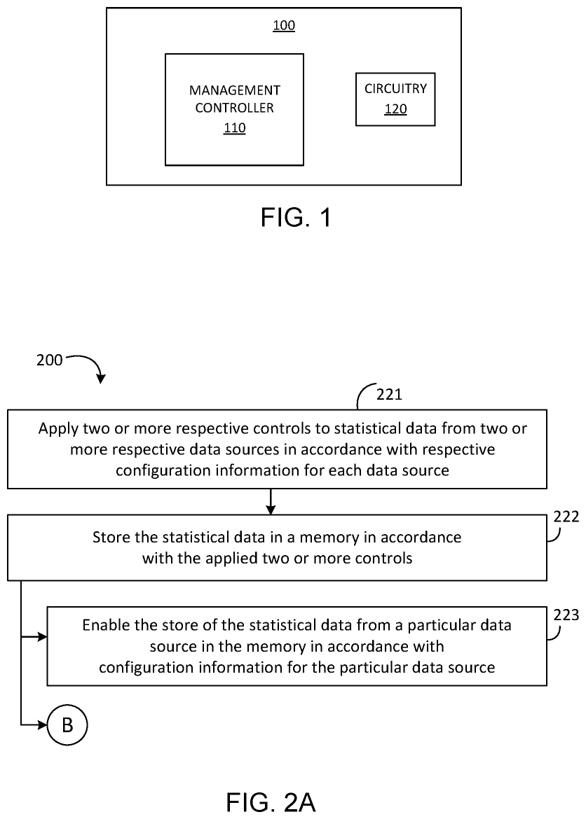

With reference to FIG. 1, an embodiment of an integrated circuit 100 may include a management controller 110 and circuitry 120 communicatively coupled to the management controller 110. The circuitry 120 may be configured to apply two or more respective controls to statistical data from two or more respective data sources in accordance with respective configuration information for each data source, and store the statistical data in a memory in accordance with the applied two or more controls. For example, the circuitry 120 may be configured to enable the store of the statistical data from a particular data source in the memory in accordance with configuration information for the particular data source. In some embodiments, the circuitry 120 may be additionally or alternatively configured to apply an accuracy control to modify an accuracy of statistical data from a particular data source in accordance with configuration information for the particular data source. For example, the circuitry 120 may be configured to change a resolution of the statistical data from the particular data source in accordance with the configuration information for the particular data source.

In some embodiments, the circuitry 120 may be additionally or alternatively configured to apply a context control to modify a context covered by statistical data from a particular data source in accordance with the configuration information for the particular data source. For example, the circuitry 120 may be configured to limit the store of the statistical data from the particular data source in the memory to data from one or more specified domains in accordance with the configuration information for the particular data source. In some embodiments, the circuitry 120 may be additionally or alternatively configured to apply an access control to set an output destination for statistical data from a particular data source in accordance with the configuration information for the particular data source. For example, the circuitry 120 may be configured to direct the statistical data from the particular data source to a protected region of the memory in accordance with the configuration information for the particular data source. In some embodiments, the circuitry 120 may be additionally or alternatively configured to apply an encryption control to encrypt statistical data from a particular data source in accordance with the configuration information for the particular data source.

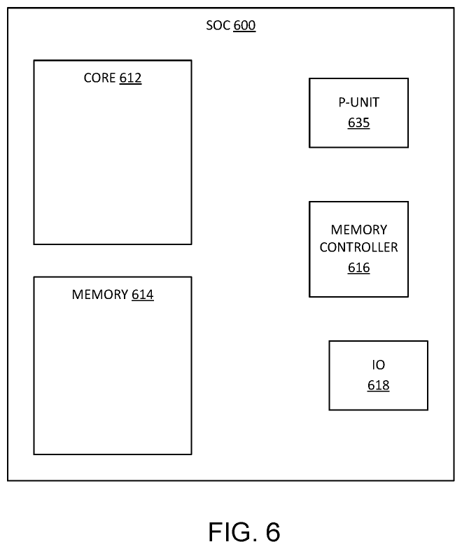

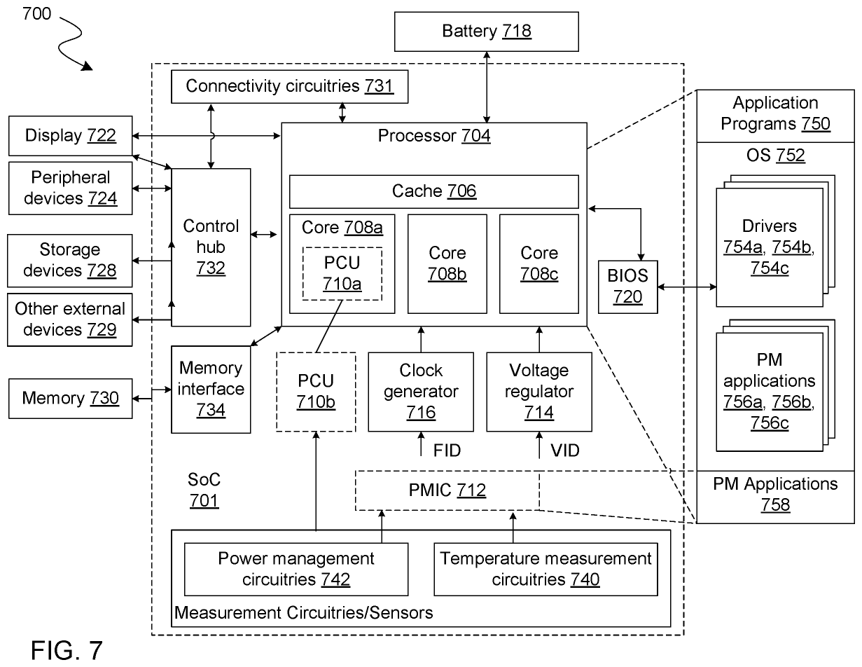

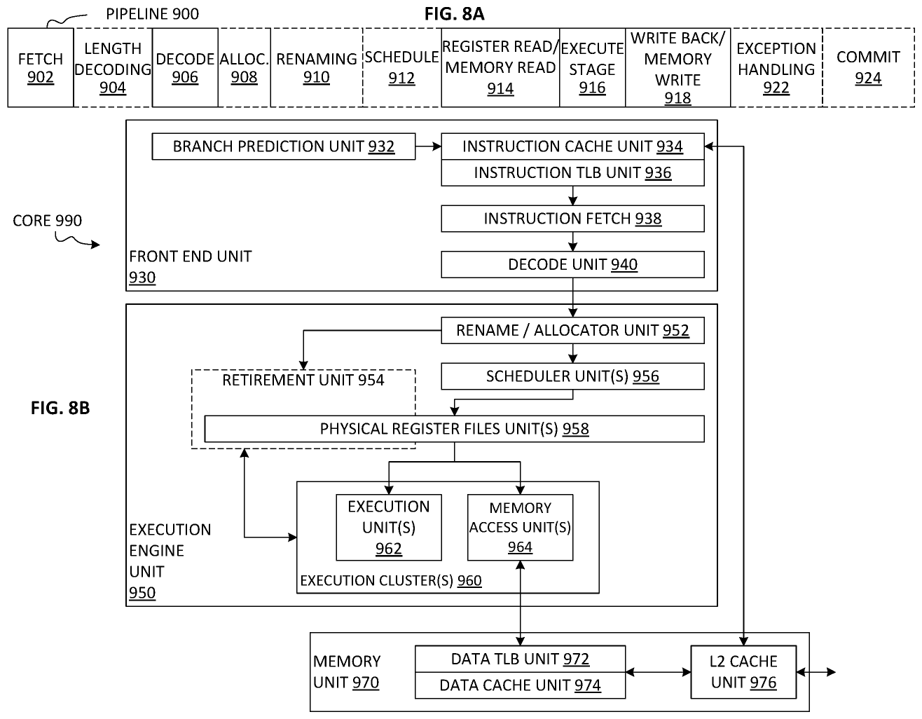

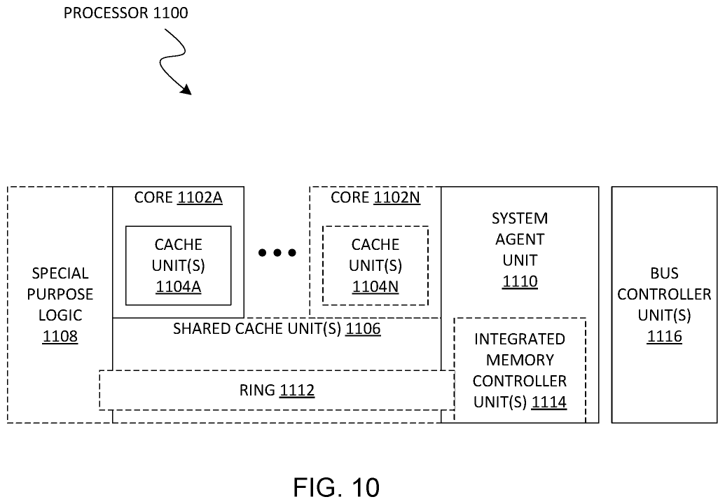

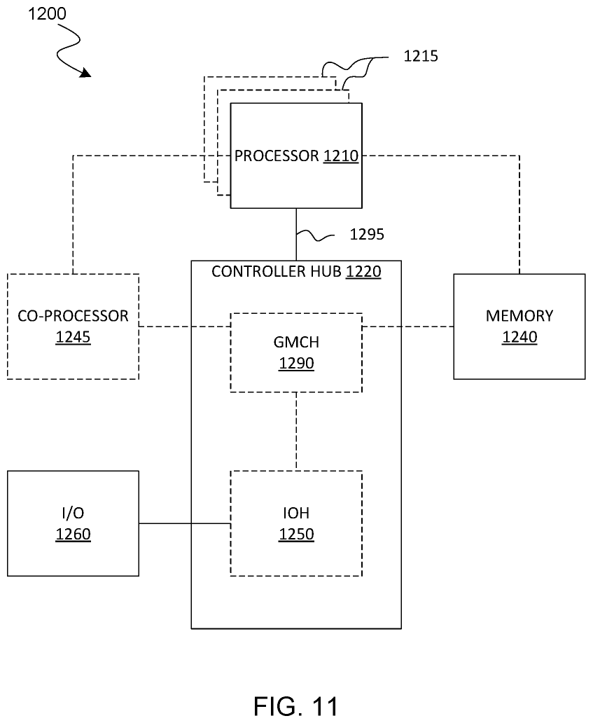

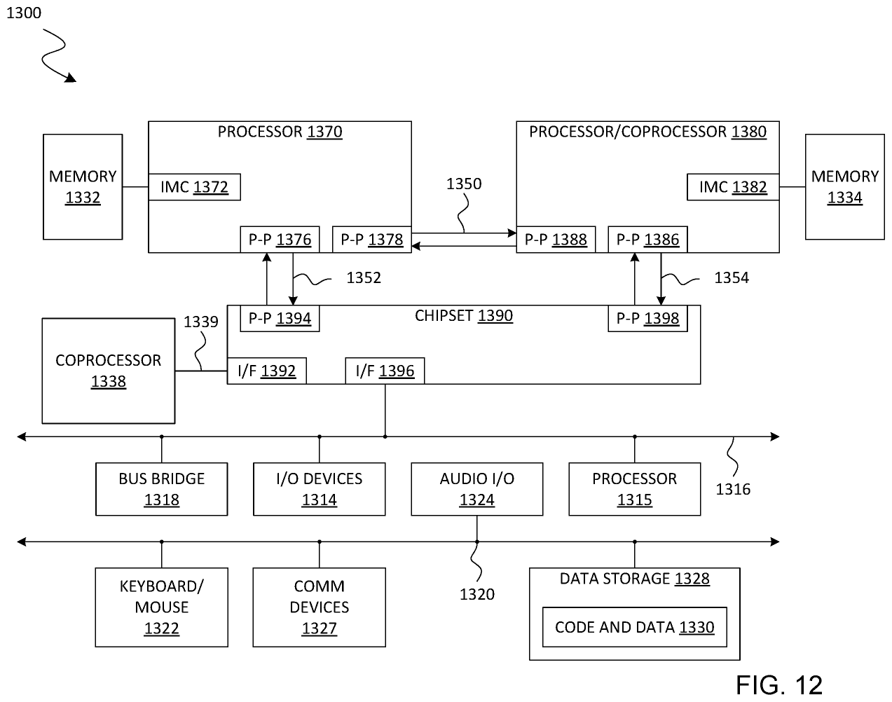

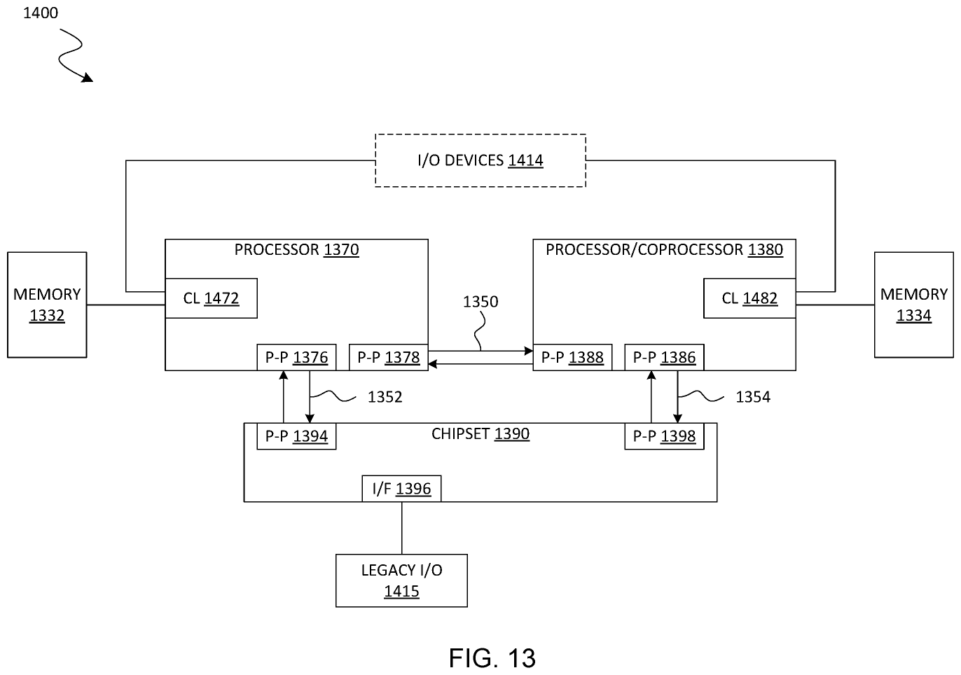

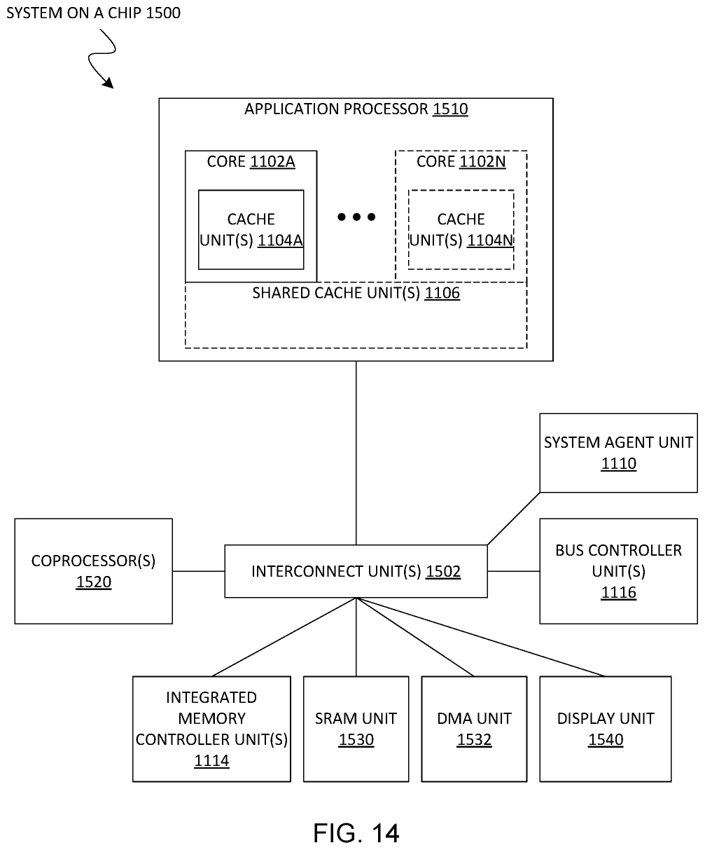

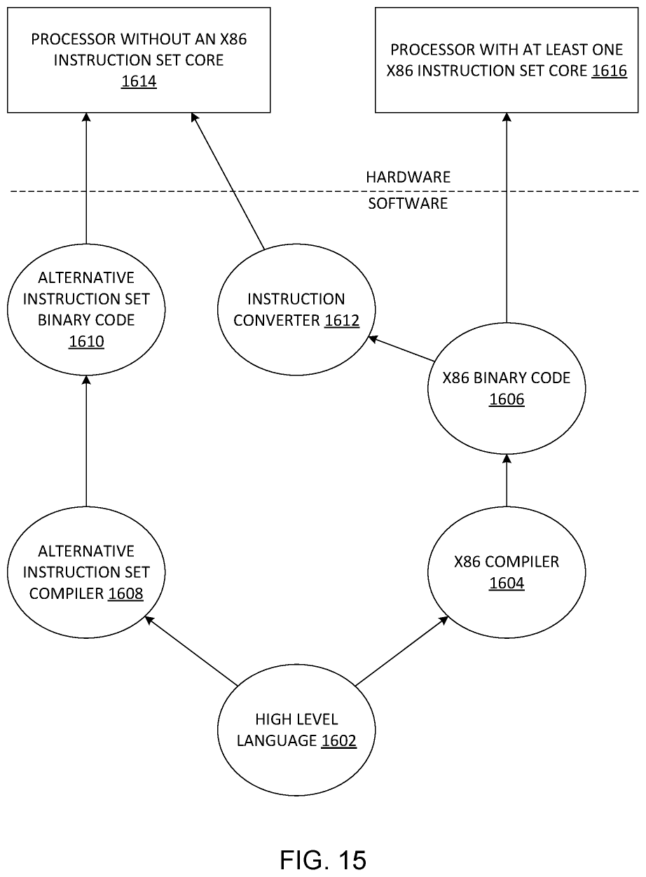

Embodiments of the management controller 110 and/or circuitry 120 may incorporated in or integrated with any suitable controller of an electronic system/platform including, for example, a PCU, a PMIC, a P-Unit, a MC, etc. Although illustrated in FIG. 1 as being separate from the management controller 110, in some embodiments all or portion of the circuitry 120 may be co-located with the management controller 110. Embodiments of the integrated circuit 100, including the management controller 110, and/or the circuitry 120, may be integrated with a processor such as those described herein including, for example, the core 612 (FIG. 6), the processor 704 (FIG. 7), the core 990 (FIG. 8B), the cores 1102A-N (FIGS. 10, 14), the processor 1210 (FIG. 11), the co-processor 1245 (FIG. 11), the processor 1370 (FIGS. 12-13), the processor/coprocessor 1380 (FIGS. 12-13), the coprocessor 1338 (FIGS. 12-13), the coprocessor 1520 (FIG. 14), and/or the processors 1614, 1616 (FIG. 15). In particular, embodiments of the circuitry 120 may be incorporated in the P-Unit 635 (FIG. 6), the PCU 710a,b (FIG. 7), and/or the PMIC 712 (FIG. 7).

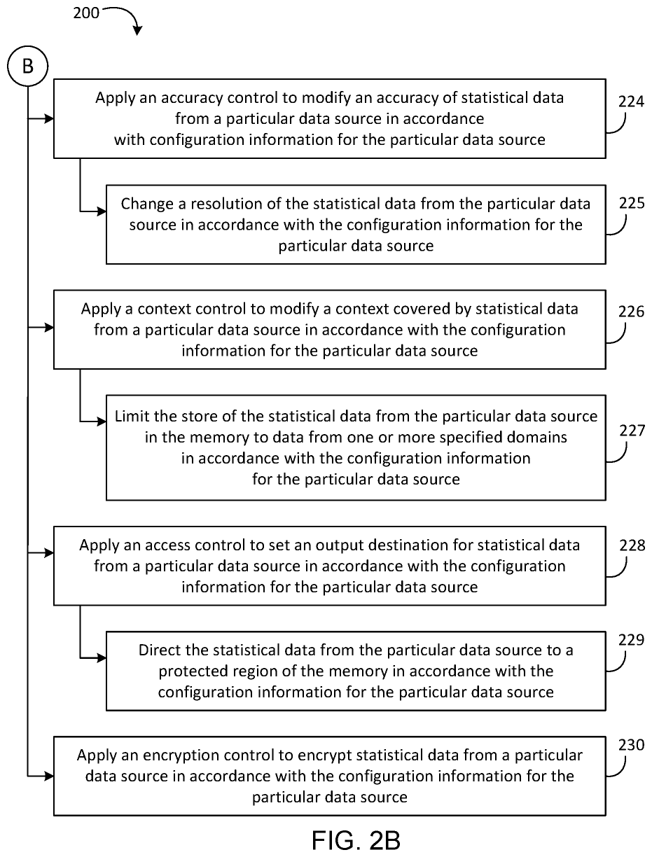

With reference to FIGS. 2A to 2B, an embodiment of a method 200 may include, at runtime, applying two or more respective controls to statistical data from two or more respective data sources in accordance with respective configuration information for each data source at box 221, and storing the statistical data in a memory in accordance with the applied two or more controls at box 222. For example, the method 200 may include enabling the store of the statistical data from a particular data source in the memory in accordance with configuration information for the particular data source at box 223. Some embodiments of the method 200 may additionally or alternatively include applying an accuracy control to modify an accuracy of statistical data from a particular data source in accordance with configuration information for the particular data source at box 224. For example, the method 200 may include changing a resolution of the statistical data from the particular data source in accordance with the configuration information for the particular data source at box 225.

Some embodiments of the method 200 may additionally or alternatively include applying a context control to modify a context covered by statistical data from a particular data source in accordance with the configuration information for the particular data source at box 226. For example, the method 200 may include limiting the store of the statistical data from the particular data source in the memory to data from one or more specified domains in accordance with the configuration information for the particular data source at box 227. Some embodiments of the method 200 may additionally or alternatively include applying an access control to set an output destination for statistical data from a particular data source in accordance with the configuration information for the particular data source at box 228. For example, the method 200 may include directing the statistical data from the particular data source to a protected region of the memory in accordance with the configuration information for the particular data source at box 229. Some embodiments of the method 200 may additionally or alternatively include applying an encryption control to encrypt statistical data from a particular data source in accordance with the configuration information for the particular data source at box 230.

Embodiments of the method 200 may be performed at runtime by a processor such as those described herein including, for example, the core 612 (FIG. 6), the processor 704 (FIG. 7), the core 990 (FIG. 8B), the cores 1102A-N (FIGS. 10, 14), the processor 1210 (FIG. 11), the co-processor 1245 (FIG. 11), the processor 1370 (FIGS. 12-13), the processor/coprocessor 1380 (FIGS. 12-13), the coprocessor 1338 (FIGS. 12-13), the coprocessor 1520 (FIG. 14), and/or the processors 1614, 1616 (FIG. 15). Alternatively, embodiments of the method 200 may be performed by a controller such as those described herein. In particular, embodiments of the method 200 may be performed by the P-Unit 635 (FIG. 6), the PCU 710a,b (FIG.7), and/or the PMIC 712 (FIG. 7).

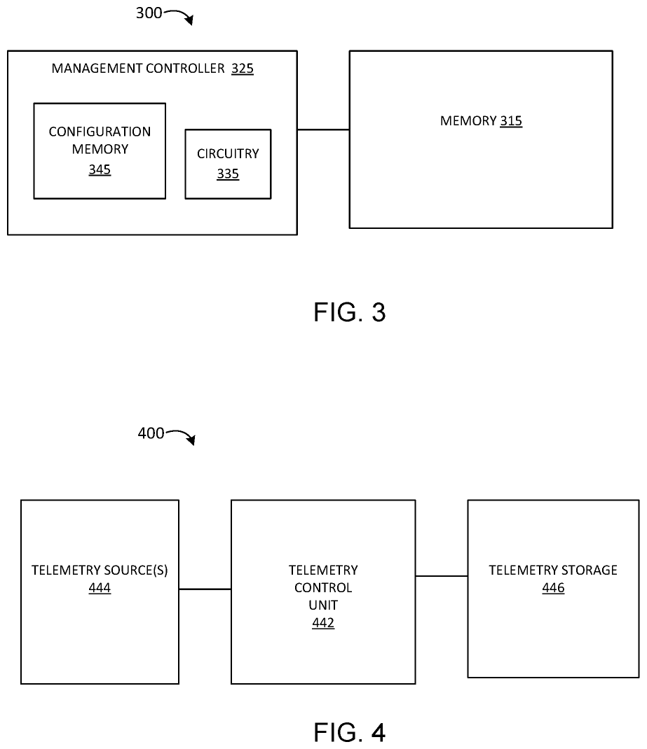

With reference to FIG. 3, an embodiment of an apparatus 300 may include a memory 315, and a management controller 325 communicatively coupled to the memory 315. The management controller 325 may include circuitry 335 to apply two or more respective controls to statistical data from two or more respective data sources in accordance with respective configuration information for each data source, and store the statistical data in the memory 315 in accordance with the applied two or more controls. In some embodiments, the management controller 325 may further include configuration memory 345 to store the configuration information. The configuration memory 345 may be implemented with any suitable storage technology such as a buffer, a set of registers, RAM, PROM, EEPROM, etc. The configuration information may have any suitable data structure, such as a table of entries for each data source and/or each data type. Each entry in the table may include one or more fields that store a value for the data source or type (e.g., either the data source itself or an identifier associated with the data source) and a value for each control associated with the data source/type (e.g., [SOURCE_ID_VALUE, ENABLE=TRUE, RESOLUTION=HALF, DOMAIN=ALL, ENCRYPT=FALSE, ACCESS=GENERAL]).

For example, the circuitry 335 may be further configured to enable the store of the statistical data from a particular data source in the memory 315 in accordance with configuration information for the particular data source. In some embodiments, the circuitry 335 may be additionally or alternatively configured to apply an accuracy control to modify an accuracy of statistical data from a particular data source in accordance with configuration information for the particular data source. For example, the circuitry 335 may be configured to change a resolution of the statistical data from the particular data source in accordance with the configuration information for the particular data source.

In some embodiments, the circuitry 335 may be additionally or alternatively configured to apply a context control to modify a context covered by statistical data from a particular data source in accordance with the configuration information for the particular data source. For example, the circuitry 335 may be configured to limit the store of the statistical data from the particular data source in the memory 315 to data from one or more specified domains in accordance with the configuration information for the particular data source. In some embodiments, the circuitry 335 may be additionally or alternatively configured to apply an access control to set an output destination for statistical data from a particular data source in accordance with the configuration information for the particular data source. For example, the circuitry 335 may be configured to direct the statistical data from the particular data source to a protected region of the memory 315 in accordance with the configuration information for the particular data source. In some embodiments, the circuitry 335 may be additionally or alternatively configured to apply an encryption control to encrypt statistical data from a particular data source in accordance with the configuration information for the particular data source.

Embodiments of the memory 315, the management controller 325, and/or the circuitry 335, may be integrated with a processor such as those described herein including, for example, the core 612 (FIG. 6), the processor 704 (FIG. 7), the core 990 (FIG. 8B), the cores 1102A-N (FIGS. 10, 14), the processor 1210 (FIG. 11), the co-processor 1245 (FIG. 11), the processor 1370 (FIGS. 12-13), the processor/coprocessor 1380 (FIGS. 12-13), the coprocessor 1338 (FIGS. 12-13), the coprocessor 1520 (FIG. 14), and/or the processors 1614, 1616 (FIG. 15). In particular, embodiments of the circuitry 335 may be incorporated in the P-Unit 635 (FIG. 6), the PCU 710a,b (FIG.7), and/or the PMIC 712 (FIG. 7).

Advantageously, some embodiments enable a response to a later-discovered concern based on statistical information to be tuned to the actual concern, thereby ensuring that the response is both feasible and at the same time will not cause an undue performance hit and/or feature degradation beyond the actual need to address the concern. For example, a secure or otherwise trusted firmware may update the configuration information at a more fine granularity to address the concern.

With reference to FIG. 4, an embodiment of a system 400 includes a telemetry control unit 442 in a data path between data from one or more telemetry sources 444 and telemetry storage 446. Embodiments of the telemetry control unit 442 include technology to combine several controls for manipulation of and access to the telemetry information. Some embodiments include granular enablement technology. Statistical information includes many different types of data such as, for example, instruction counts, power consumption, memory accesses, etc. Some embodiments provide an Enable/Disable control of each type of data, instead of a global control that Enables/Disables all statistical information collection.

Some embodiments of the telemetry control unit 442 may additionally or alternatively include technology for granular resolution control. In some cases, the resolution of the collected data can be controlled to mitigate a concern or problem with the statistical information. For example, the sampling rate of the data can be reduced, or the accuracy of the results can be reduced. Adjusting the resolution of the data may mitigate a side channel attack while still providing useful information to authorized entities. Some embodiments may provide resolution control of each type of statistical information collection.

Some embodiments of the telemetry control unit 442 may additionally or alternatively include technology for a granular domain control. In some cases, the domain for which the statistical information may be controlled to mitigate a concern or problem with the statistical information. For example, a counter that collects information about all the workloads in the system may be limited to only include information on a specific application or virtual machine. Some embodiments may provide domain control of each type of statistical information collection.

Some embodiments of the telemetry control unit 442 may additionally or alternatively include technology for access control. By default, all statistical information may be output to a system memory location that is accessible to all software. Some embodiments may control the output destination of each type of data. Each type of data may be directed to a protected region of memory rather than general purpose system memory. Access to protected memory may be restricted to specific hardware or firmware agents, or to TEEs, and may not be accessed by normal, unprivileged software.

Some embodiments of the telemetry control unit 442 may additionally or alternatively include technology for data encryption. By default, all statistical information may be output in raw form, without any post-processing. Some embodiments may encrypt specific types of data. Each specified type of data may be encrypted before the data is stored in memory, thereby limiting access to the data to a trusted entity that supports encryption/decryption of the data.

In some embodiments, configuration of the above controls may be set by trusted firmware (e.g., signed firmware) at reset of the system. When needed, the firmware can be updated by patching mechanisms in the field in order to adjust the telemetry information controls in response to new concerns.

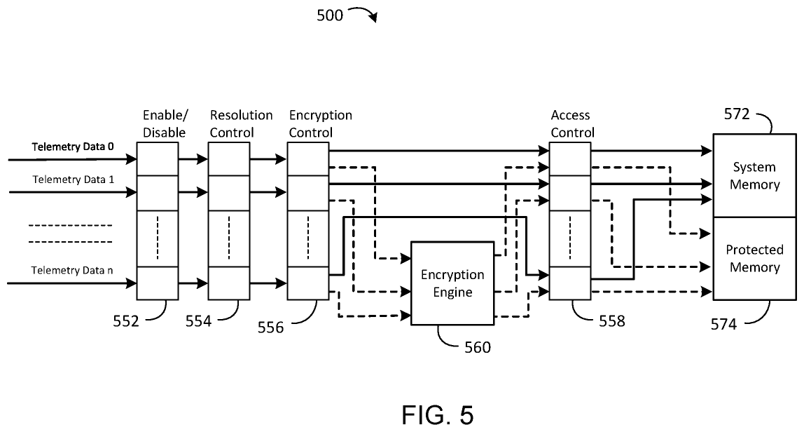

With reference to FIG. 5, an embodiment of a process flow 500 for controlled exposure of statistical information. Multiple sources of telemetry data (0 through n, n>0) pass through multiple control stages before the data is stored. As illustrated, the multiple control stages include an enable stage 552, a resolution control stage 554, an encryption control stage 556, and an access control stage 558. Other embodiments may include different control stages, a different order of the stages, more stages, or fewer stages. Data that is indicated for encryption further passes through an encryption engine 560. After each of the preceding controls are applied, the data is directed to either a general region of memory (e.g., system memory 572) or a secure region of memory (e.g., protected memory 574).

Each source of telemetry data 0 through n has controls applied at each stage as configured for that source. For example, the protected memory 574 may store configuration information for each source of telemetry data 0 through n that indicates whether data collection for that source is enabled, what resolution is applied to data from that source, whether or not data from that source is encrypted, and whether the resulting data after the preceding controls are applied is stored in system memory 572 or protected memory 574. Advantageously, each source of data may be handled differently and finer granularity of control may be applied to each source of data.

With reference to FIG. 6, an embodiment of a system-on-a-chip (SoC) 600 includes a core 612, memory 614, a memory controller 616, and an IO interface 618, all coupled to each other through suitable interfaces, buses, and interconnects. The SoC 600 further includes a P-Unit 635 coupled with the other components of the SoC to manage power and other operations of the core 612 and the other components. In accordance with some embodiments, the P-Unit 635 is further configured with telemetry control technology as described herein to control exposure of statistical information. For example, the core 612, memory 614, memory controller 616 and I0 interface 618 may each include various sensors, detectors, counters, etc. that measure different diagnostic and/or performance information and capture data of the same. Such data may be considered as telemetry data from multiple sources within the SoC 600. The telemetry data may be utilized by various hardware, firmware, and/or software agents to tune various aspects of the operation of the hardware/firmware/software/etc.

In some embodiments, the telemetry data may pass through the P-Unit 635 before the telemetry data is stored in the memory 614 (e.g., which may include a protected region). For example, the P-Unit 635 may be configured with control technology for granular enablement, granular resolution, granular domains, encryption, and/or access control as described herein. In some embodiments, configuration of the above controls may be set by trusted firmware (e.g., signed firmware) at reset of the system. When needed, the firmware can be updated by patching mechanisms in the field in order to adjust the telemetry information controls in response to new concerns.

FIG. 7 illustrates a computer system or computing device 700 (also referred to as device 700), where telemetry control technology, in accordance with some embodiments, controls exposure of statistical information.

In some embodiments, device 700 represents an appropriate computing device, such as a computing tablet, a mobile phone or smart-phone, a laptop, a desktop, an Internet-of-Things (IOT) device, a server, a wearable device, a set-top box, a wireless-enabled e-reader, or the like. It will be understood that certain components are shown generally, and not all components of such a device are shown in device 700.

In an example, the device 700 comprises a SoC 701. An example boundary of the SoC 701 is illustrated using dotted lines in FIG. 7, with some example components being illustrated to be included within SoC 701—however, SoC 701 may include any appropriate components of device 700.

In some embodiments, device 700 includes processor 704. Processor 704 can include one or more physical devices, such as microprocessors, application processors, microcontrollers, programmable logic devices, processing cores, or other processing means. The processing operations performed by processor 704 include the execution of an operating platform or operating system on which applications and/or device functions are executed. The processing operations include operations related to I/O (input/output) with a human user or with other devices, operations related to power management, operations related to connecting computing device 700 to another device, and/or the like. The processing operations may also include operations related to audio I/O and/or display I/O.

In some embodiments, processor 704 includes multiple processing cores (also referred to as cores) 708a, 708b, 708c. Although merely three cores 708a, 708b, 708c are illustrated in FIG. 7, the processor 704 may include any other appropriate number of processing cores, e.g., tens, or even hundreds of processing cores. Processor cores 708a, 708b, 708c may be implemented on a single integrated circuit (IC) chip. Moreover, the chip may include one or more shared and/or private caches, buses or interconnections, graphics and/or memory controllers, or other components.

In some embodiments, processor 704 includes cache 706. In an example, sections of cache 706 may be dedicated to individual cores 708 (e.g., a first section of cache 706 dedicated to core 708a, a second section of cache 706 dedicated to core 708b, and so on). In an example, one or more sections of cache 706 may be shared among two or more of cores 708. Cache 706 may be split in different levels, e.g., level 1 (L1) cache, level 2 (L2) cache, level 3 (L3) cache, etc.

In some embodiments, processor core 704 may include a fetch unit to fetch instructions (including instructions with conditional branches) for execution by the core 704. The instructions may be fetched from any storage devices such as the memory 730. Processor core 704 may also include a decode unit to decode the fetched instruction. For example, the decode unit may decode the fetched instruction into a plurality of micro-operations. Processor core 704 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 704 may be an out-of-order processor core in one embodiment. Processor core 704 may also include a retirement unit. The retirement unit may retire executed instructions after they are committed. In an embodiment, retirement of the executed instructions may result in processor state being committed from the execution of the instructions, physical registers used by the instructions being de-allocated, etc. The processor core 704 may also include a bus unit to enable communication between components of the processor core 704 and other components via one or more buses. Processor core 704 may also include one or more registers to store data accessed by various components of the core 704 (such as values related to assigned app priorities and/or sub-system states (modes) association.

In some embodiments, device 700 comprises connectivity circuitries 731. For example, connectivity circuitries 731 includes hardware devices (e.g., wireless and/or wired connectors and communication hardware) and/or software components (e.g., drivers, protocol stacks), e.g., to enable device 700 to communicate with external devices. Device 700 may be separate from the external devices, such as other computing devices, wireless access points or base stations, etc.

In an example, connectivity circuitries 731 may include multiple different types of connectivity. To generalize, the connectivity circuitries 731 may include cellular connectivity circuitries, wireless connectivity circuitries, etc. Cellular connectivity circuitries of connectivity circuitries 731 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 731 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 731 may include a network interface, such as a wired or wireless interface, e.g., so that a system embodiment may be incorporated into a wireless device, for example, cell phone or personal digital assistant.

In some embodiments, device 700 comprises control hub 732, which represents hardware devices and/or software components related to interaction with one or more I/O devices. For example, processor 704 may communicate with one or more of display 722, one or more peripheral devices 724, storage devices 728, one or more other external devices 729, etc., via control hub 732. Control hub 732 may be a chipset, a Platform Control Hub (PCH), and/or the like.

For example, control hub 732 illustrates one or more connection points for additional devices that connect to device 700, e.g., through which a user might interact with the system. For example, devices (e.g., devices 729) that can be attached to device 700 include microphone devices, speaker or stereo systems, audio devices, video systems or other display devices, keyboard or keypad devices, or other I/O devices for use with specific applications such as card readers or other devices.

As mentioned above, control hub 732 can interact with audio devices, display 722, etc. For example, input through a microphone or other audio device can provide input or commands for one or more applications or functions of device 700. Additionally, audio output can be provided instead of, or in addition to display output. In another example, if display 722 includes a touch screen, display 722 also acts as an input device, which can be at least partially managed by control hub 732. There can also be additional buttons or switches on computing device 700 to provide I/O functions managed by control hub 732. In one embodiment, control hub 732 manages devices such as accelerometers, cameras, light sensors or other environmental sensors, or other hardware that can be included in device 700. The input can be part of direct user interaction, as well as providing environmental input to the system to influence its operations (such as filtering for noise, adjusting displays for brightness detection, applying a flash for a camera, or other features).

In some embodiments, control hub 732 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 722 represents hardware (e.g., display devices) and software (e.g., drivers) components that provide a visual and/or tactile display for a user to interact with device 700. Display 722 may include a display interface, a display screen, and/or hardware device used to provide a display to a user. In some embodiments, display 722 includes a touch screen (or touch pad) device that provides both output and input to a user. In an example, display 722 may communicate directly with the processor 704. Display 722 can be one or more of an internal display device, as in a mobile electronic device or a laptop device or an external display device attached via a display interface (e.g., DisplayPort, etc.). In one embodiment display 722 can be a head mounted display (HMD) such as a stereoscopic display device for use in virtual reality (VR) applications or augmented reality (AR) applications.

In some embodiments and although not illustrated in the figure, in addition to (or instead of) processor 704, device 700 may include Graphics Processing Unit (GPU) comprising one or more graphics processing cores, which may control one or more aspects of displaying contents on display 722.

Control hub 732 (or platform controller hub) may include hardware interfaces and connectors, as well as software components (e.g., drivers, protocol stacks) to make peripheral connections, e.g., to peripheral devices 724.

It will be understood that device 700 could both be a peripheral device to other computing devices, as well as have peripheral devices connected to it. Device 700 may have a “docking” connector to connect to other computing devices for purposes such as managing (e.g., downloading and/or uploading, changing, synchronizing) content on device 700. Additionally, a docking connector can allow device 700 to connect to certain peripherals that allow computing device 700 to control content output, for example, to audiovisual or other systems.

In addition to a proprietary docking connector or other proprietary connection hardware, device 700 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 731 may be coupled to control hub 732, e.g., in addition to, or instead of, being coupled directly to the processor 704. In some embodiments, display 722 may be coupled to control hub 732, e.g., in addition to, or instead of, being coupled directly to processor 704.

In some embodiments, device 700 comprises memory 730 coupled to processor 704 via memory interface 734. Memory 730 includes memory devices for storing information in device 700. Memory can include nonvolatile (state does not change if power to the memory device is interrupted) and/or volatile (state is indeterminate if power to the memory device is interrupted) memory devices. Memory device 730 can be a dynamic random access memory (DRAM) device, a static random access memory (SRAM) device, flash memory device, phase-change memory device, or some other memory device having suitable performance to serve as process memory. In one embodiment, memory 730 can operate as system memory for device 700, to store data and instructions for use when the one or more processors 704 executes an application or process. Memory 730 can store application data, user data, music, photos, documents, or other data, as well as system data (whether long-term or temporary) related to the execution of the applications and functions of device 700.

Elements of various embodiments and examples are also provided as a machine-readable medium (e.g., memory 730) for storing the computer-executable instructions (e.g., instructions to implement any other processes discussed herein). The machine-readable medium (e.g., memory 730) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 700 comprises temperature measurement circuitries 740, e.g., for measuring temperature of various components of device 700. In an example, temperature measurement circuitries 740 may be embedded, or coupled or attached to various components, whose temperature are to be measured and monitored. For example, temperature measurement circuitries 740 may measure temperature of (or within) one or more of cores 708a, 708b, 708c, voltage regulator 714, memory 730, a mother-board of SoC 701, and/or any appropriate component of device 700.

In some embodiments, device 700 comprises power measurement circuitries 742, e.g., for measuring power consumed by one or more components of the device 700. In an example, in addition to, or instead of, measuring power, the power measurement circuitries 742 may measure voltage and/or current. In an example, the power measurement circuitries 742 may be embedded, or coupled or attached to various components, whose power, voltage, and/or current consumption are to be measured and monitored. For example, power measurement circuitries 742 may measure power, current and/or voltage supplied by one or more voltage regulators 714, power supplied to SoC 701, power supplied to device 700, power consumed by processor 704 (or any other component) of device 700, etc.

In some embodiments, device 700 comprises one or more voltage regulator circuitries, generally referred to as voltage regulator (VR) 714. VR 714 generates signals at appropriate voltage levels, which may be supplied to operate any appropriate components of the device 700. Merely as an example, VR 714 is illustrated to be supplying signals to processor 704 of device 700. In some embodiments, VR 714 receives one or more Voltage Identification (VID) signals, and generates the voltage signal at an appropriate level, based on the VID signals. Various type of VRs may be utilized for the VR 714. For example, VR 714 may include a “buck” VR, “boost” VR, a combination of buck and boost VRs, low dropout (LDO) regulators, switching DC-DC regulators, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR which is controlled by PCU 710a/b and/or PMIC 712. In some embodiments, each core has a network of distributed LDOs to provide efficient control for power management. The LDOs can be digital, analog, or a combination of digital or analog LDOs.

In some embodiments, device 700 comprises one or more clock generator circuitries, generally referred to as clock generator 716. Clock generator 716 generates clock signals at appropriate frequency levels, which may be supplied to any appropriate components of device 700. Merely as an example, clock generator 716 is illustrated to be supplying clock signals to processor 704 of device 700. In some embodiments, clock generator 716 receives one or more Frequency Identification (FID) signals, and generates the clock signals at an appropriate frequency, based on the FID signals.

In some embodiments, device 700 comprises battery 718 supplying power to various components of device 700. Merely as an example, battery 718 is illustrated to be supplying power to processor 704. Although not illustrated in the figures, device 700 may comprise a charging circuitry, e.g., to recharge the battery, based on Alternating Current (AC) power supply received from an AC adapter.

In some embodiments, device 700 comprises Power Control Unit (PCU) 710 (also referred to as Power Management Unit (PMU), Power Controller, etc.). In an example, some sections of PCU 710 may be implemented by one or more processing cores 708, and these sections of PCU 710 are symbolically illustrated using a dotted box and labelled PCU 710a. In an example, some other sections of PCU 710 may be implemented outside the processing cores 708, and these sections of PCU 710 are symbolically illustrated using a dotted box and labelled as PCU 710b. PCU 710 may implement various power management operations for device 700. PCU 710 may include hardware interfaces, hardware circuitries, connectors, registers, etc., as well as software components (e.g., drivers, protocol stacks), to implement various power management operations for device 700.

In some embodiments, device 700 comprises Power Management Integrated Circuit (PMIC) 712, e.g., to implement various power management operations for device 700. In some embodiments, PMIC 712 is a Reconfigurable Power Management ICs (RPMICs) and/or an IMVP (Intel® Mobile Voltage Positioning). In an example, the PMIC is within an IC chip separate from processor 704. The may implement various power management operations for device 700. PMIC 712 may include hardware interfaces, hardware circuitries, connectors, registers, etc., as well as software components (e.g., drivers, protocol stacks), to implement various power management operations for device 700.

In an example, device 700 comprises one or both PCU 710 or PMIC 712. In an example, any one of PCU 710 or PMIC 712 may be absent in device 700, and hence, these components are illustrated using dotted lines.

Various power management operations of device 700 may be performed by PCU 710, by PMIC 712, or by a combination of PCU 710 and PMIC 712. For example, PCU 710 and/or PMIC 712 may select a power state (e.g., P-state) for various components of device 700. For example, PCU 710 and/or PMIC 712 may select a power state (e.g., in accordance with the ACPI (Advanced Configuration and Power Interface) specification) for various components of device 700. Merely as an example, PCU 710 and/or PMIC 712 may cause various components of the device 700 to transition to a sleep state, to an active state, to an appropriate C state (e.g., CO state, or another appropriate C state, in accordance with the ACPI specification), etc. In an example, PCU 710 and/or PMIC 712 may control a voltage output by VR 714 and/or a frequency of a clock signal output by the clock generator, e.g., by outputting the VID signal and/or the FID signal, respectively. In an example, PCU 710 and/or PMIC 712 may control battery power usage, charging of battery 718, and features related to power saving operation.

The clock generator 716 can comprise a phase locked loop (PLL), frequency locked loop (FLL), or any suitable clock source. In some embodiments, each core of processor 704 has its own clock source. As such, each core can operate at a frequency independent of the frequency of operation of the other core. In some embodiments, PCU 710 and/or PMIC 712 performs adaptive or dynamic frequency scaling or adjustment. For example, clock frequency of a processor core can be increased if the core is not operating at its maximum power consumption threshold or limit. In some embodiments, PCU 710 and/or PMIC 712 determines the operating condition of each core of a processor, and opportunistically adjusts frequency and/or power supply voltage of that core without the core clocking source (e.g., PLL of that core) losing lock when the PCU 710 and/or PMIC 712 determines that the core is operating below a target performance level. For example, if a core is drawing current from a power supply rail less than a total current allocated for that core or processor 704, then PCU 710 and/or PMIC 712 can temporarily increase the power draw for that core or processor 704 (e.g., by increasing clock frequency and/or power supply voltage level) so that the core or processor 704 can perform at higher performance level. As such, voltage and/or frequency can be increased temporarily for processor 704 without violating product reliability.

In an example, PCU 710 and/or PMIC 712 may perform power management operations, e.g., based at least in part on receiving measurements from power measurement circuitries 742, temperature measurement circuitries 740, charge level of battery 718, and/or any other appropriate information that may be used for power management. To that end, PMIC 712 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 710 and/or PMIC 712 in at least one embodiment to allow PCU 710 and/or PMIC 712 to manage processor core energy at least in part based on value(s) detected by one or more of the sensors.

Also illustrated is an example software stack of device 700 (although not all elements of the software stack are illustrated). Merely as an example, processors 704 may execute application programs 750, Operating System 752, one or more Power Management (PM) specific application programs (e.g., generically referred to as PM applications 758), and/or the like. PM applications 758 may also be executed by the PCU 710 and/or PMIC 712. OS 752 may also include one or more PM applications 756a, 756b, 756c. The OS 752 may also include various drivers 754a, 754b, 754c, etc., some of which may be specific for power management purposes. In some embodiments, device 700 may further comprise a Basic Input/Output System (BIOS) 720. BIOS 720 may communicate with OS 752 (e.g., via one or more drivers 754), communicate with processors 704, etc.

For example, one or more of PM applications 758, 756, drivers 754, BIOS 720, etc. may be used to implement power management specific tasks, e.g., to control voltage and/or frequency of various components of device 700, to control wake-up state, sleep state, and/or any other appropriate power state of various components of device 700, control battery power usage, charging of the battery 718, features related to power saving operation, etc.

In some embodiments, multiple tasks are variously performed each with a respective one of application programs 750 and/or OS 752. At a given time during operation of computing device 700, at least some of the tasks each result in, or otherwise correspond to, a respective input being received via one or more human interface devices (HIDs). Said tasks each further include or otherwise correspond to a different respective data flow by which computing device 700 communicates with one or more networks (e.g., via connectivity circuitries 731). User input and/or other characteristics of user behavior are detected with the one or more HIDs, and provide a basis for detecting a relative interest by the user in one task over one or more other copending tasks. By way of illustration and not limitation, OS 752 provides a kernel space in which QoS logic, a filter driver, and/or other suitable software logic executes to detect a task which is currently of relatively greater user interest, and to prioritize a data flow which corresponds to said task. An indication of the relative prioritization of tasks (e.g., and the relative prioritization of corresponding data flows) is communicated, for example, from processor 704 to connectivity circuitries 731. Based on such signaling, connectivity circuitries 731 variously processes data packets according to the prioritization of tasks relative to each other.

In accordance with some embodiments, the PMIC 712 and/or a PCU (e.g., such as PCU 710a inside the core 708a, or such as the PCU 710b outside the processor 704) is further configured with telemetry control technology as described herein to control exposure of statistical information. In some embodiments, the telemetry data may pass through the suitably configured PCU/PMIC before the telemetry data is stored in the memory 730 (e.g., which may include a protected region). For example, the PCU/PMIC may be configured with control technology for granular enablement, granular resolution, granular domains, encryption, and/or access control as described herein. In some embodiments, configuration of the above controls may be set by trusted firmware (e.g., signed firmware) at reset of the system. When needed, the firmware can be updated by patching mechanisms in the field in order to adjust the telemetry information controls in response to new concerns.

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 8B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

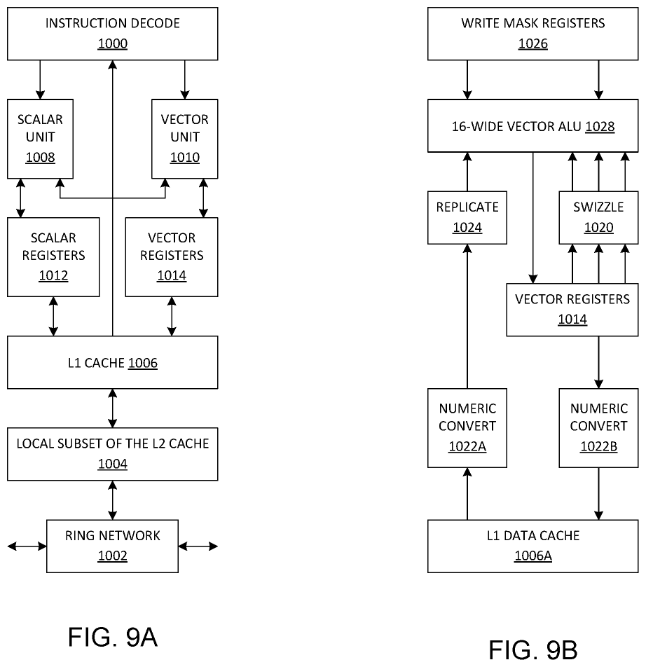

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to embodiments of the invention. FIG. 9B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

FIG. 10 is a block diagram of a processor 1100 that may have more than one core, may have an integrated memory controller, and may have integrated graphics according to embodiments of the invention. The solid lined boxes in FIG. 10 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Exemplary Computer Architectures

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 11 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 12, shown is a block diagram of a first more specific exemplary system 1300 in accordance with an embodiment of the present invention. As shown in FIG. 12, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 12, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 12, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 12, a system may implement a multi-drop bus or other such architecture.

Referring now to FIG. 13, shown is a block diagram of a second more specific exemplary system 1400 in accordance with an embodiment of the present invention Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1370, 1380 may include integrated memory and I/O control logic (“CL”) 1472 and 1482, respectively. Thus, the CL 1472, 1482 include integrated memory controller units and include I/O control logic. FIG. 13 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

Referring now to FIG. 14, shown is a block diagram of a SoC 1500 in accordance with an embodiment of the present invention. Similar elements in FIG. 10 bear like reference numerals. Also, dashed lined boxes are optional features on more advanced SoCs. In FIG. 14, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 15 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Techniques and architectures for controlled exposure of statistical information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

### ADDITIONAL NOTES AND EXAMPLES

Example 1 includes an integrated circuit, comprising a management controller, and circuitry communicatively coupled to the management controller, the circuitry to apply two or more respective controls to statistical data from two or more respective data sources in accordance with respective configuration information for each data source, and store the statistical data in a memory in accordance with the applied two or more controls.

Example 2 includes the integrated circuit of Example 1, wherein the circuitry is further to enable the store of the statistical data from a particular data source in the memory in accordance with configuration information for the particular data source.

Example 3 includes the integrated circuit of any of Examples 1 to 2, wherein the circuitry is further to apply an accuracy control to modify an accuracy of statistical data from a particular data source in accordance with configuration information for the particular data source.

Example 4 includes the integrated circuit of Example 3, wherein the circuitry is further to change a resolution of the statistical data from the particular data source in accordance with the configuration information for the particular data source.

Example 5 includes the integrated circuit of any of Examples 1 to 4, wherein the circuitry is further to apply a context control to modify a context covered by statistical data from a particular data source in accordance with the configuration information for the particular data source.

Example 6 includes the integrated circuit of Example 5, wherein the circuitry is further to limit the store of the statistical data from the particular data source in the memory to data from one or more specified domains in accordance with the configuration information for the particular data source.

Example 7 includes the integrated circuit of any of Examples 1 to 6, wherein the circuitry is further to apply an access control to set an output destination for statistical data from a particular data source in accordance with the configuration information for the particular data source.

Example 8 includes the integrated circuit of Example 7, wherein the circuitry is further to direct the statistical data from the particular data source to a protected region of the memory in accordance with the configuration information for the particular data source.

Example 9 includes the integrated circuit of any of Examples 1 to 8, wherein the circuitry is further to apply an encryption control to encrypt statistical data from a particular data source in accordance with the configuration information for the particular data source.

Example 10 includes a method, comprising applying two or more respective controls to statistical data from two or more respective data sources in accordance with respective configuration information for each data source, and storing the statistical data in a memory in accordance with the applied two or more controls.

Example 11 includes the method of Example 10, further comprising enabling the store of the statistical data from a particular data source in the memory in accordance with configuration information for the particular data source.

Example 12 includes the method of any of Examples 10 to 11, further comprising applying an accuracy control to modify an accuracy of statistical data from a particular data source in accordance with configuration information for the particular data source.

Example 13 includes the method of Example 12, further comprising changing a resolution of the statistical data from the particular data source in accordance with the configuration information for the particular data source.

Example 14 includes the method of any of Examples 10 to 13, further comprising applying a context control to modify a context covered by statistical data from a particular data source in accordance with the configuration information for the particular data source.

Example 15 includes the method of Example 14, further comprising limiting the store of the statistical data from the particular data source in the memory to data from one or more specified domains in accordance with the configuration information for the particular data source.

Example 16 includes the method of any of Examples 10 to 15, further comprising applying an access control to set an output destination for statistical data from a particular data source in accordance with the configuration information for the particular data source.

Example 17 includes the method of Example 16, further comprising directing the statistical data from the particular data source to a protected region of the memory in accordance with the configuration information for the particular data source.

Example 18 includes the method of any of Examples 10 to 17, further comprising applying an encryption control to encrypt statistical data from a particular data source in accordance with the configuration information for the particular data source.

Example 19 includes an apparatus, comprising a memory, a management controller communicatively coupled to the memory, the management controller including circuitry to apply two or more respective controls to statistical data from two or more respective data sources in accordance with respective configuration information for each data source, and store the statistical data in the memory in accordance with the applied two or more controls.

Example 20 includes the apparatus of Example 19, wherein the circuitry is further to enable the store of the statistical data from a particular data source in the memory in accordance with configuration information for the particular data source.

Example 21 includes the apparatus of any of Examples 19 to 20, wherein the circuitry is further to apply an accuracy control to modify an accuracy of statistical data from a particular data source in accordance with configuration information for the particular data source.

Example 22 includes the apparatus of Example 21, wherein the circuitry is further to change a resolution of the statistical data from the particular data source in accordance with the configuration information for the particular data source.

Example 23 includes the apparatus of any of Examples 19 to 22, wherein the circuitry is further to apply a context control to modify a context covered by statistical data from a particular data source in accordance with the configuration information for the particular data source.

Example 24 includes the apparatus of Example 23, wherein the circuitry is further to limit the store of the statistical data from the particular data source in the memory to data from one or more specified domains in accordance with the configuration information for the particular data source.

Example 25 includes the apparatus of any of Examples 19 to 24, wherein the circuitry is further to apply an access control to set an output destination for statistical data from a particular data source in accordance with the configuration information for the particular data source.

Example 26 includes the apparatus of Example 25, wherein the circuitry is further to direct the statistical data from the particular data source to a protected region of the memory in accordance with the configuration information for the particular data source.

Example 27 includes the apparatus of any of Examples 19 to 26, wherein the circuitry is further to apply an encryption control to encrypt statistical data from a particular data source in accordance with the configuration information for the particular data source.

Example 28 includes an apparatus, comprising means for applying two or more respective controls to statistical data from two or more respective data sources in accordance with respective configuration information for each data source, and means for storing the statistical data in a memory in accordance with the applied two or more controls.

Example 29 includes the apparatus of Example 28, further comprising means for enabling the store of the statistical data from a particular data source in the memory in accordance with configuration information for the particular data source.

Example 30 includes the apparatus of any of Examples 28 to 29, further comprising means for applying an accuracy control to modify an accuracy of statistical data from a particular data source in accordance with configuration information for the particular data source.

Example 31 includes the apparatus of Example 30, further comprising means for changing a resolution of the statistical data from the particular data source in accordance with the configuration information for the particular data source.

Example 32 includes the apparatus of any of Examples 28 to 31, further comprising means for applying a context control to modify a context covered by statistical data from a particular data source in accordance with the configuration information for the particular data source.

Example 33 includes the apparatus of Example 32, further comprising means for limiting the store of the statistical data from the particular data source in the memory to data from one or more specified domains in accordance with the configuration information for the particular data source.

Example 34 includes the apparatus of any of Examples 28 to 33, further comprising means for applying an access control to set an output destination for statistical data from a particular data source in accordance with the configuration information for the particular data source.

Example 35 includes the apparatus of Example 34, further comprising means for directing the statistical data from the particular data source to a protected region of the memory in accordance with the configuration information for the particular data source.

Example 36 includes the apparatus of any of Examples 28 to 35, further comprising means for applying an encryption control to encrypt statistical data from a particular data source in accordance with the configuration information for the particular data source.

Example 37 includes at least one non-transitory machine readable medium comprising a plurality of instructions that, in response to being executed on a computing device, cause the computing device to apply two or more respective controls to statistical data from two or more respective data sources in accordance with respective configuration information for each data source, and store the statistical data in a memory in accordance with the applied two or more controls.

Example 38 includes the at least one non-transitory machine readable medium of Example 37, comprising a plurality of further instructions that, in response to being executed on the computing device, cause the computing device to enable the store of the statistical data from a particular data source in the memory in accordance with configuration information for the particular data source.

Example 39 includes the at least one non-transitory machine readable medium of any of Examples 37 to 38, comprising a plurality of further instructions that, in response to being executed on the computing device, cause the computing device to apply an accuracy control to modify an accuracy of statistical data from a particular data source in accordance with configuration information for the particular data source.

Example 40 includes the at least one non-transitory machine readable medium of Example 39, comprising a plurality of further instructions that, in response to being executed on the computing device, cause the computing device to change a resolution of the statistical data from the particular data source in accordance with the configuration information for the particular data source.

Example 41 includes the at least one non-transitory machine readable medium of any of Examples 37 to 40, comprising a plurality of further instructions that, in response to being executed on the computing device, cause the computing device to apply a context control to modify a context covered by statistical data from a particular data source in accordance with the configuration information for the particular data source.

Example 42 includes the at least one non-transitory machine readable medium of Example 41, comprising a plurality of further instructions that, in response to being executed on the computing device, cause the computing device to limit the store of the statistical data from the particular data source in the memory to data from one or more specified domains in accordance with the configuration information for the particular data source.

Example 43 includes the at least one non-transitory machine readable medium of any of Examples 37 to 42, comprising a plurality of further instructions that, in response to being executed on the computing device, cause the computing device to apply an access control to set an output destination for statistical data from a particular data source in accordance with the configuration information for the particular data source.

Example 44 includes the at least one non-transitory machine readable medium of Example 43, comprising a plurality of further instructions that, in response to being executed on the computing device, cause the computing device to direct the statistical data from the particular data source to a protected region of the memory in accordance with the configuration information for the particular data source.

Example 45 includes the at least one non-transitory machine readable medium of any of Examples 37 to 44, comprising a plurality of further instructions that, in response to being executed on the computing device, cause the computing device to apply an encryption control to encrypt statistical data from a particular data source in accordance with the configuration information for the particular data source.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit, comprising:
a management controller; and
circuitry communicatively coupled to the management controller, the circuitry to:
apply two or more respective controls to statistical data from two or more respective data sources in accordance with respective configuration information for each data source, and
store the statistical data in a memory in accordance with the applied two or more controls.

2. The integrated circuit of claim 1, wherein the circuitry is further to:
enable the store of the statistical data from a particular data source in the memory in accordance with configuration information for the particular data source.

3. The integrated circuit of claim 1, wherein the circuitry is further to:
apply an accuracy control to modify an accuracy of statistical data from a particular data source in accordance with configuration information for the particular data source.

4. The integrated circuit of claim 3, wherein the circuitry is further to:
change a resolution of the statistical data from the particular data source in accordance with the configuration information for the particular data source.

5. The integrated circuit of claim 1, wherein the circuitry is further to:
apply a context control to modify a context covered by statistical data from a particular data source in accordance with the configuration information for the particular data source.

6. The integrated circuit of claim 5, wherein the circuitry is further to:
limit the store of the statistical data from the particular data source in the memory to data from one or more specified domains in accordance with the configuration information for the particular data source.

7. The integrated circuit of claim 1, wherein the circuitry is further to:
apply an encryption control to encrypt statistical data from a particular data source in accordance with the configuration information for the particular data source.

8. A method, comprising:
applying two or more respective controls to statistical data from two or more respective data sources in accordance with respective configuration information for each data source; and
storing the statistical data in a memory in accordance with the applied two or more controls.

9. The method of claim 8, further comprising:
enabling the store of the statistical data from a particular data source in the memory in accordance with configuration information for the particular data source.

10. The method of claim 8, further comprising:
applying an accuracy control to modify an accuracy of statistical data from a particular data source in accordance with configuration information for the particular data source.

11. The method of claim 10, further comprising:
changing a resolution of the statistical data from the particular data source in accordance with the configuration information for the particular data source.

12. The method of claim 8, further comprising:
applying an access control to set an output destination for statistical data from a particular data source in accordance with the configuration information for the particular data source.

13. The method of claim 12, further comprising:
directing the statistical data from the particular data source to a protected region of the memory in accordance with the configuration information for the particular data source.

14. The method of claim 8, further comprising:
applying an encryption control to encrypt statistical data from a particular data source in accordance with the configuration information for the particular data source.

15. An apparatus, comprising:
a memory;
a management controller communicatively coupled to the memory, the management controller including circuitry to:
apply two or more respective controls to statistical data from two or more respective data sources in accordance with respective configuration information for each data source, and
store the statistical data in the memory in accordance with the applied two or more controls.

16. The apparatus of claim 15, wherein the circuitry is further to:
apply an accuracy control to modify an accuracy of statistical data from a particular data source in accordance with configuration information for the particular data source.

17. The apparatus of claim 16, wherein the circuitry is further to:
change a resolution of the statistical data from the particular data source in accordance with the configuration information for the particular data source.

18. The apparatus of claim 15, wherein the circuitry is further to:
apply a context control to modify a context covered by statistical data from a particular data source in accordance with the configuration information for the particular data source.

19. The apparatus of claim 18, wherein the circuitry is further to:
limit the store of the statistical data from the particular data source in the memory to data from one or more specified domains in accordance with the configuration information for the particular data source.

20. The apparatus of claim 15, wherein the circuitry is further to:
apply an access control to set an output destination for statistical data from a particular data source in accordance with the configuration information for the particular data source.

21. The apparatus of claim 20, wherein the circuitry is further to:
direct the statistical data from the particular data source to a protected region of the memory in accordance with the configuration information for the particular data source.
